(19) United States
(12) Patent Application Publication
(10) Pub. No.: US 2012/0047915 A1
(43) Pub. Date: Mar. 1, 2012

(54) CONVEYOR BELT PROVIDING GEYSERING EFFECT

(76) Inventors: Stephen A. McCormick, Warrington, PA (US); Simon Shamoun, Acworth, GA (US)

(21) Appl. No.: 12/861,860

(22) Filed: Aug. 24, 2010

(51) Int. Cl. F25D 13/06; B65G 17/00; F25D 25/04

(52) U.S. Cl. 62/63; 62/380; 198/804

(57) ABSTRACT

A conveyor belt for freezers includes at least one support member having an upper surface upon which product is supported for being conveyed, a lower surface opposed to said upper surface and at least one hole extending through the support member between the upper and lower surfaces for permitting fluid at the lower surface to pass through the at least one hole to the upper surface and contact the product thereon.

The present invention relates to conveyor belts which transport products such as food products through a freezer.

The disadvantage of known conveyor belts is that they cannot impart motion to products, such as food products, carried thereon with respect to surrounding or adjacent products and therefore, a higher percentage of clumped product occurs during transit upon the belt. In addition, a surface of the products that rests upon the conveyor belt does not get uniformly chilled or frozen as does the remaining exposed surfaces of the products.

### BRIEF DESCRIPTION OF THE DRAWINGS

For a more complete understanding of the present embodiments, reference may be had to the following drawing figures taken in conjunction with the description of the embodiments, of which:

FIG. 1 shows a top perspective view of a portion of a conveyor belt embodiment of the invention;

FIG. 2 shows another top perspective view of a portion of the conveyor belt embodiment of FIG. 1;

FIG. 3 shows a side view of a freezer having the conveyor belt embodiment of the present invention; and

FIG. 4 shows the conveyor belt embodiment of FIG. 3 disposed for use in another freezer.

### DESCRIPTION OF THE INVENTION

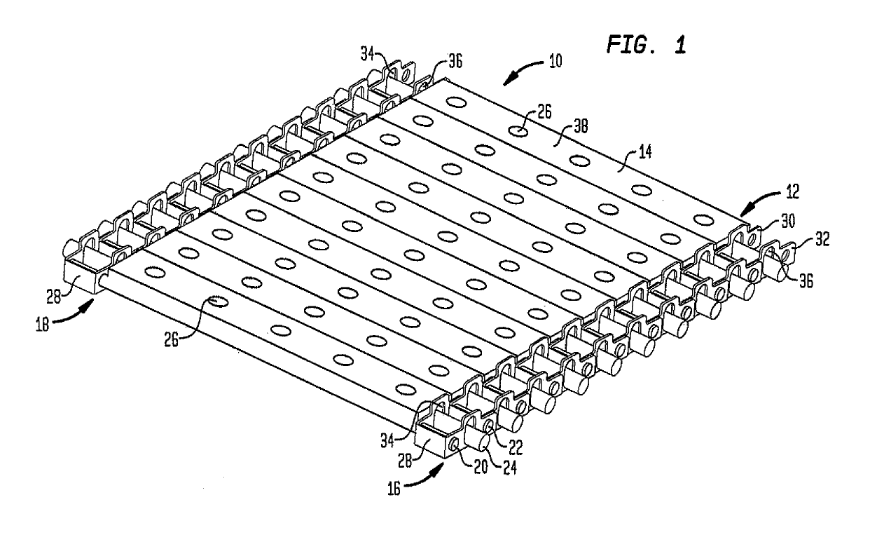

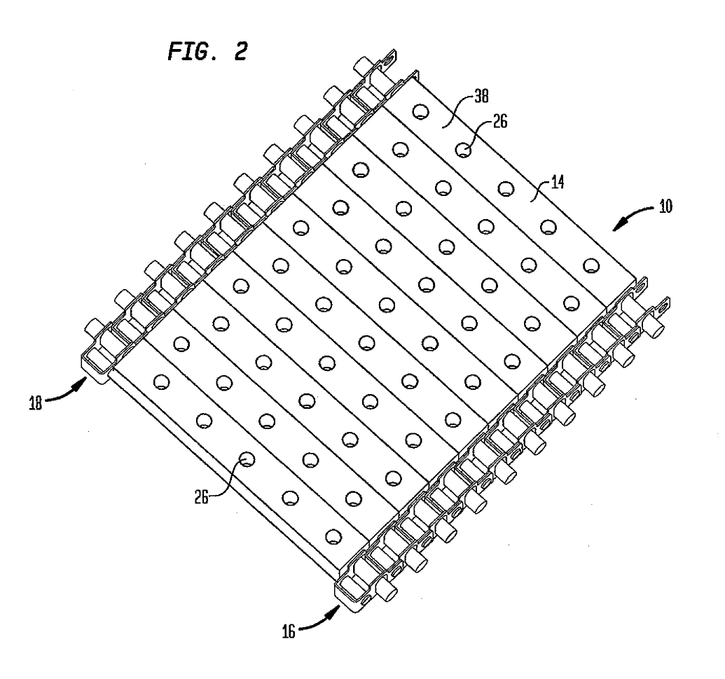

Referring to FIGS. 1 and 2, a portion of a conveyor belt embodiment is shown generally at 10, which includes a plurality of support members 12 for transporting a product (not shown) such as a food product for freezing, for example. The conveyor belt 10 due to its structure as further described below is adapted for use in cryogen immersion tanks, such as tanks with liquid nitrogen (N₂). Each one of the support members 12 consists of a product support surface 14, a pair of side links 16, 18, a pair of pins 20, 22, and a rod 24. The pins 20, 22 extend between each opposed pair of side links 16, 18 to interconnect said side links 16, 18.

The side links 16, 18, the pins 20, 22, and the rod 24 are manufactured from stainless steel. The support member 14 may be manufactured from plastic or stainless steel and includes at least one hole 26 and if necessary a plurality of the holes 26 extending through each one of the support members 14. Each support member may be up to 12 mm thick (0.5 inches) in depth, and have a length of up to 1.2 m (4 feet).

The pins 20, 22 interconnect opposed side links 16, 18 as shown in FIGS. 1 and 2. Each one of the side links is constructed with a U-shape, such that each side link 16, 18 is provided with a base portion 28 interconnecting an opposed set of arms 30, 32. An open end of each side link 16, 18 opposite to the base portion 28 is sized and shaped to receive the base portion 28 of an adjacent one of the side links 16, 18 as shown.

Each one of the pair of arms 30, 32 has formed therein an oblong-shape aperture 34, 36 which are in registration with each other for receiving a corresponding one of the pins 24. Such construction permits the pin 24 to be displaced vertically in the apertures 34, 36. The support member 14 is mounted to a corresponding one of the pins 24, and therefore, displaced vertical movement of the pin 24 also causes the support member 14 to move as well. In effect, the support members 14 can move independently of each other as they transit through a conveying operation, such as through a nitrogen immersion bath.

Still referring to FIGS. 1 and 2, the apertures 26 which extend through each one of the support members 14 permit fluid that may be disposed beneath the conveyor belt 10 for moving upward through the apertures 26 to contact product at an upper surface 38 of the support member 14.

When the conveyor belt 10 is used to transport the product through a cryogen fluid, such as in a nitrogen immersion bath, the ambient temperature of the belt 10 when exposed to the cryogen provides for a rapid and aggressive heat transfer which produces bubbling or “boiling” at the bath. Such boiling provides a force capable of causing the cryogen fluid through the apertures 26 and due to the constricted space of such apertures 26 a geysering effect is provided at the upper surface 38 of the support members 14 to contact the product thereon. The term “geyser” or variations thereof used herein mean the turbulent, forceful eruption of fluid or fluid and gas, regardless of temperature.

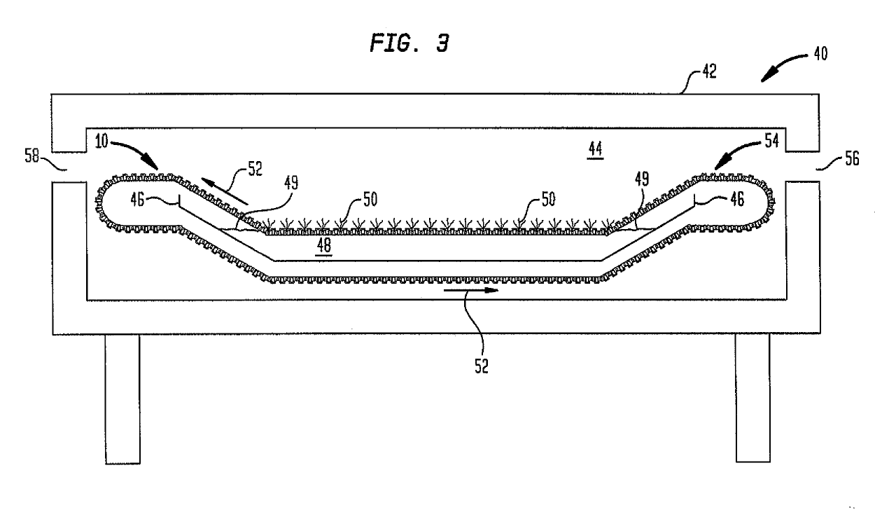

Referring now to FIG. 3, the conveyor belt embodiment 10 is shown arranged in a continuous loop mounted for use within a freezer 40. The freezer 40 includes a housing 42 within which is provided a chamber 44. A cryogen immersion bath 46 is provided in the chamber 44 to hold liquid cryogen, such as for example a cryogen bath 48 of nitrogen. A surface of the bath 48 is shown at 49.

As shown in FIG. 3, when the conveyor belt 10, being of an ambient temperature or at a temperature greater than that of the nitrogen bath 48, contacts the nitrogen bath 48 geysers 50 are produced as the nitrogen boils off and expands to erupt through the apertures 26 of the support members 14. In addition, the force which occurs as a result of the geysering, causes turbulence in the nitrogen bath 48 such that small rivulets or waves are produced which impact the belt 10. However, because the support members 14 are displaceable due to the coaction between the rod 16 and the oblong shaped apertures 34, 36, each one of the support members 14 can move independent of the remaining support members so that a fluid, articulating belt having geysers of nitrogen erupting at the upper surface 38 is provided which prevents clumping of the product and also provides better access of the cryogen to contact an underside of the product being frozen.

Eventually, the conveyor belt 10, moving in the direction of arrows 52, transits out of the nitrogen bath 48, whereupon the geysering effect lessens and then eventually ceases as the belt becomes less under the effect of heat transfer with respect to the nitrogen bath 48. As the belt 10 continues in its continuous loop it will eventually return to a “starting position” designated generally at 54 for retrieving new product at an inlet 56 of the freezer housing 42. The return loop or section of the belt 10 is external to the nitrogen bath 48 so it immediately begins to warm, i.e. seek ambient temperature of the chamber 44, as it moves to the starting position 54. The temperature of the belt 10 is warmed sufficiently such that upon re-entry of the belt into the nitrogen bath 48 the geysering will again occur.

An outlet 58 enables the frozen product to be discharged from an “end position” designated generally at 60 of the freezer housing 42 after the product is conveyed through the bath 48.

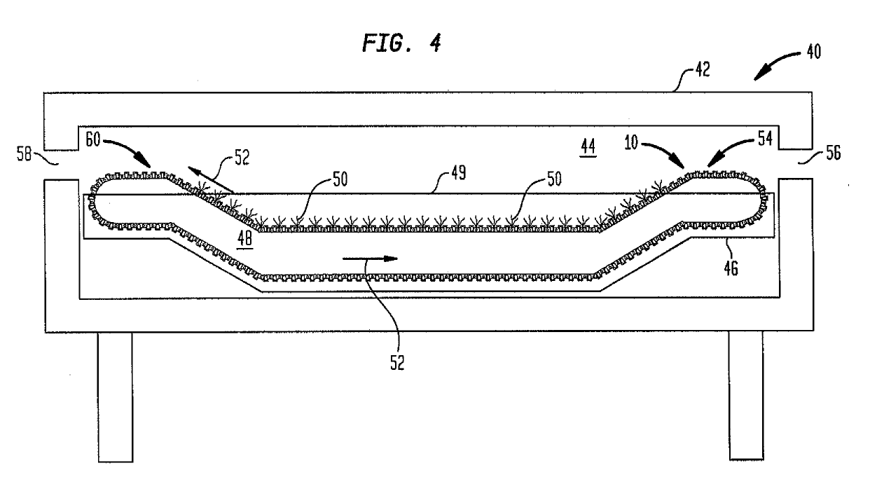

FIG. 4 shows an alternative embodiment of the conveyor belt used with the cryogen bath. In the embodiment of FIG. 4, a return loop or section of the conveyor belt is substantially disposed in the nitrogen bath 48. Therefore, the heat transfer that will occur to provide the geysering effect will essentially take place with respect to new or fresh product being introduced at the inlet 56 onto the support members 14 of the conveyor belt 10 which, upon exposure to the nitrogen bath 48, will provide the necessary heat transfer for “boiling” to occur.

Although the embodiment in FIG. 4 shows the conveyor belt 10 as a continuous loop, it should be understood that both a feed conveyor (not shown) for the inlet 56 at the starting position 54 and a discharge conveyor (not shown) for the outlet 58 at the end position 60 can also be used to feed and discharge the product with respect to the chamber 44. In addition, instead of the conveyor belt 10 being arranged as a continuous loop within the housing, the belt 10 can extend through the inlet 56 and the outlet 58, but not have a return run in the housing 42 or the bath 48.

A top section of the belt 10 in the bath 48 of FIGS. 3 and 4 is approximately 2 mm-25 mm below the surface 49 of the bath 48. Such an arrangement of the belt 10 in the bath 48 provides for the necessary freezing of the product, exposure to cryogen geysering, and prevents the product from floating off the upper surface 38 of the belt 10.

By way of example only, the size of the holes 26 in the support member 14 may have a diameter of approximately 3 mm, and a depth of up to 12 mm. The depth of the holes 26 will extend through the support member 14. The arrangement of the holes 26 in the support members 14 can be in a uniform or staggered pattern.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. A conveyor belt for freezers, comprising:
at least one support member having an upper surface upon which product is supported for being conveyed, a lower surface opposed to said upper surface and at least one hole extending through the support member between the upper and lower surfaces for permitting fluid at the lower surface to pass through the at least one hole to the upper surface and contact the product thereon.

2. The conveyor belt of claim 1, wherein the at least one hole is constructed and arranged to coact with the fluid to provide a geyser of the fluid to contact the product at the upper surface of the at least one support member.

3. The conveyor belt of claim 1, wherein the conveyor belt comprises a plurality of the support surfaces moveably displaceable with respect to each other.

4. The conveyor belt of claim 3, wherein each one of the support members comprises a plurality of the holes.

5. The conveyor belt of claim 4, wherein the holes are arranged in a uniform pattern across the conveyor belt.

6. The conveyor belt of claim 1, further comprising a housing having a chamber therein in which the conveyor belt is disposed, and a bath of liquid cryogen disposed in the chamber and through which at least an upper tier portion of the conveyor belt is moved.

7. The conveyor belt of claim 6, wherein the liquid cryogen comprises nitrogen.

8. The conveyor belt of claim 6, wherein the housing comprises an inlet for introducing the product to the conveyor belt and an outlet through which the product is removed from the conveyor belt.

9. The conveyor belt of claim 1, wherein the at least one hole comprises a diameter of 3 mm, and a length up to 12 mm.

10. The conveyor belt of claim 6, wherein a lower tier portion of the conveyor belt is disposed to move through the bath of liquid cryogen.

11. The conveyor belt of claim 6, wherein the upper tier portion of the conveyor belt is disposed from 3 mm to 25 mm beneath a surface of the bath.

12. The conveyor belt of claim 1, wherein the support member is constructed from plastic.

13. The conveyor belt of claim 1, wherein the product comprises a food product.

14. A method of freezing a product with a conveyor belt, comprising:
conveying the product on an upper surface of the conveyor belt having a plurality of holes therethrough extending through to a lower surface of the conveyor belt;
contacting the lower surface with a liquid cryogen for erupting the liquid cryogen through the plurality of holes to provide a plurality of geysers of liquid cryogen spray to the upper surface to contact the product, and
freezing the product with the liquid cryogen spray at the upper surface.

15. The method of claim 14, wherein the liquid cryogen comprises nitrogen.
